(19) United States
(12) Patent Application Publication
(10) Pub. No.: US 2008/0159551 A1
(43) Pub. Date: Jul. 3, 2008

(54) System and Method for Acoustic Echo Removal (AER)

(75) Inventors: Thomas Randall Harley, Columbia, MD (US); Bogdan Kosanovic, Bethesda, MD (US); Puneet Gupta, New Delhi (IN)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/693,850

(22) Filed: Mar. 30, 2007

Related U.S. Application Data
(60) Provisional application No. 60/877,594, filed on Dec. 28, 2006.

(51) Int. Cl. H04B 3/20

(52) U.S. Cl. 381/66

(57) ABSTRACT

One embodiment of the present invention includes an acoustic echo removal system. A transmit signal and a receive signal each having high and low frequency portions, are propagated between a microphone and at least one voice processor. A first acoustic echo removal portion determines and provides a first variable attenuation gain to the low-frequency portion of the transmit signal at a first sample frequency and provides a second variable attenuation gain to the low-frequency portion of the receive signal at the first sample frequency. A second acoustic echo removal portion provides the first variable attenuation gain to the high-frequency portion of the transmit signal at a second sample frequency and provides the second variable attenuation gain to both the high-frequency portion of the receive signal and a copy of the low-frequency portion of the receive signal at the second sample frequency.

### CROSS REFERENCE TO RELATED APPLICATIONS

This application claims the benefit of provisional patent application No. 60/877,594 which was filed on Dec. 28, 2006, and entitled SYSTEM AND METHOD FOR ACOUSTIC ECHO REMOVAL (AER), and which is incorporated herein by reference.

### TECHNICAL FIELD

This invention relates to communications devices, and more specifically to a system and method for acoustic echo removal (AER).

### BACKGROUND

In voice communication applications, acoustic echo is a condition that results in a user hearing an echo of his or her own voice through the near-end speaker of his or her voice communication device. Acoustic echo can result from, for example, a microphone at a far-end voice communication device receiving the voice signal from the far-end speaker and retransmitting it. Thus, acoustic echo is typically delayed when it is received at the near-end voice communication device. As such, acoustic echo can greatly disrupt conversational speech in voice communications.

Solutions for removing acoustic echo have been implemented. One such solution is acoustic echo cancellation. Acoustic echo cancellation, as used herein, refers to applying an adaptive filter technique to adaptively monitor received voice data and subsequently subtract linearly predicted interference (e.g., acoustic echo) from the voice data that is to he transmitted to the far-end voice communication device. However, acoustic echo cancellation is typically not sufficient to completely remove acoustic echo, resulting in some acoustic echo data passing through to be transmitted. In addition, acoustic echo cancellation often requires large amounts of additional computational resources.

Another solution to removing acoustic echo is the attenuation of data that is not required to he transmitted from one voice communication device to another. This approach is often referred to as acoustic echo suppression. Acoustic echo suppression is typically implemented at the near-end voice communication device by attenuating the received data when the user is speaking and/or attenuating data to be transmitted when the user is not speaking, thus preventing the far-end user from experiencing acoustic echo. However, acoustic echo suppression alone is not suitable for completely removing acoustic echo, particularly during double-talk, when both users are speaking substantially concurrently. Acoustic echo suppression requires additional computational resources. Coupled together, acoustic echo cancellation and acoustic echo suppression would require even greater amounts of computational resources, thus introducing additional undesirable communication delays in the voice communication between two users.

### SUMMARY

One embodiment of the present invention includes an acoustic echo removal system that comprises a transmit path configured to propagate a transmit signal between a microphone and at least one voice processor. The acoustic echo removal system also comprises a receive path configured to propagate a receive signal between the at least one voice processor and a speaker. The transmit signal and the receive signal each have a high-frequency portion and a low-frequency portion. The acoustic echo removal system also comprises a first acoustic echo removal portion configured to determine a first variable attenuation gain and to provide the first variable attenuation gain to the low-frequency portion of the transmit signal at a first sample frequency and to provide a second variable attenuation gain to the low-frequency portion of the receive signal at the first sample frequency. The acoustic echo removal system further comprises a second acoustic echo removal portion configured to provide the first variable attenuation gain to the high-frequency portion of the transmit signal at a second sample frequency and to provide the second variable attenuation gain to both the high-frequency portion of the receive signal and a copy of the low-frequency portion of the receive signal at the second sample frequency.

Another embodiment of the present invention includes an acoustic echo removal system. The acoustic echo removal system comprises a receive-path bandsplitter configured to split a receive signal into a high-frequency portion, a low-frequency portion, and a copy of the low-frequency portion. The acoustic echo removal system can also comprise a receive-path downsampler configured to reduce a sample frequency associated with the low-frequency portion of the receive signal from a first sample frequency to a second sample frequency. The acoustic echo removal system can also comprise a receive-path portion of a non-linear processor configured to apply a receive attenuation gain to the low-frequency portion of the receive signal at the second sample frequency. The acoustic echo removal system can also comprise a receive-path attenuator configured to apply the receive attenuation gain to both the high-frequency portion of the receive signal and a copy of the low-frequency portion of the receive signal at the first sample frequency. The acoustic echo removal system can further comprise a receive-path adder configured to add the high-frequency portion and the copy of the low-frequency portion of the receive signal to generate an attenuated receive signal

Another embodiment of the present invention includes a method of removing acoustic echo in a voice communication device. The method comprises bandsplitting a transmit signal into a high-frequency portion and a low-frequency portion and subtracting a compensation component from the high-frequency portion of the transmit signal. The compensation component can comprise distortion associated with at least one of normalization, downsampling, upsampling, and low-pass filtering of the low-frequency portion of the transmit signal. The method can also comprise downsampling the low-frequency portion of the transmit signal from a first sample frequency to a second sample frequency and applying a first variable attenuation gain on the low-frequency portion of the transmit signal at the second sample frequency and on the high-frequency portion of the transmit signal at the first sample frequency. The method can further comprise upsampling the low-frequency portion of the transmit signal from the second sample frequency to the first sample frequency and adding the low-frequency portion and the high-frequency portion of the transmit signal to generate an attenuated transmit signal, such that the attenuated transmit signal is a substantially identical reconstruction of the transmit signal.

### BRIEF DESCRIPTION OF THE DRAWINGS

FIG. 1 illustrates an example of a voice communication device in accordance with an aspect of the invention,

FIG. 2 illustrates another example of a voice communication device in accordance with an aspect of the invention.

FIG. 3 illustrates an example of a bandsplitter in accordance with an aspect of the invention,

FIG. 4 illustrates an example of an acoustic echo removal non-linear processor in accordance with an aspect of the invention.

FIG. 5 illustrates a method for removing acoustic echo in a receive path of a voice communication device in accordance with an aspect of the invention.

FIG. 6 illustrates a method for removing acoustic echo in a transmit path of a voice communication device in accordance with an aspect of the invention.

### DETAILED DESCRIPTION

The present invention relates to communications devices, and more specifically to a system and method for acoustic echo removal (AER). It is to be understood that, as it is used herein, the term “acoustic echo removal” encompasses acoustic echo cancellation and/or acoustic echo suppression. A voice communication device can include an acoustic echo removal system that includes an AER shell and an AER core. In the AER shell a transmit path and a receive path are both bandsplit, such that each of a transmit signal and a receive signal comprise a high-frequency portion and a low-frequency portion. The low-frequency portions of each of the receive signal and the transmit signal are downsampled and input to the AER core.

The AER core performs acoustic echo removal from the low-frequency portions of each of the receive signal and the transmit signal. For example, the AER core can perform both acoustic echo cancellation and acoustic echo suppression. When performing acoustic echo suppression on the low-frequency portions of the transmit signal and the receive signal the AER core can communicate attenuation information to the high-frequency portions of the receive signal and the transmit signal in the AER shell. Thus, the high-frequency portions of the receive signal and/or the transmit signal can be attenuated the same as the low-frequency portions. In addition, the AER core can communicate the attenuation information to a copy of the low-frequency portion of the receive signal in the AER shell. As such, the copy of the low-frequency portion of the receive signal can be added to the high-frequency portion of the receive signal to generate an attenuated receive signal. Therefore, the low-frequency portion of the receive signal need not be upsampled, thus eliminating delays associated with additional computational resources.

In the transmit path, upon bandsplitting the receive signal, a compensation component can be subtracted from the high-frequency portion of the transmit signal. Thus, upon upsampling the low-frequency portion of the transmit signal and adding it to the high-frequency portion of the transmit signal, as will be described below, distortion that has been introduced into the low-frequency portion of the transmit signal can be eliminated from the resultant attenuated transmit signal. Therefore, the attenuated transmit signal can he a substantially identical reconstruction of the transmit signal. Furthermore, the bandsplitting operation of each of the transmit signal and the receive signal can also ensure a more efficient and more accurate reproduction of the signals. For example, a low-pass filter (LPF) can be implemented to obtain the low-frequency portions, and the high-frequency portions can be mathematically derived based on the low-frequency portion relative to the respective transmit signal and/or receive signal.

It is to be understood that, during selected portions of a given call, the transmit path and/or the receive path may not actually be attenuated by the AER system (i.e., attenuation gain factor of 1), such as upon a determination of the respective one of the transmit path and the receive path as being the dominant path. However, it is to be understood that, as used herein, the terms “attenuated transmit signal” and “attenuated receive signal” are used to define the portions of the transmit signal and the receive signal, respectively, that are output from the AER system, regardless of whether the respective signal is actually attenuated or not at the given time. Specifically, the attenuated transmit signal is output from the AER system and input to the voice processor(s), and the attenuated receive signal is output from the AER system and provided to the speaker of the communication device, as is described below. Furthermore, as described herein, a given frequency associated with the transmit signal and/or the receive signal, including the respective low-frequency portions, high-frequency portions, and wide-bands, refers to the spectral content of the transmit signal and/or the receive signal having the given frequency. A sampling frequency refers to a frequency at which the respective transmit signal and/or receive signal is sampled, as used herein.

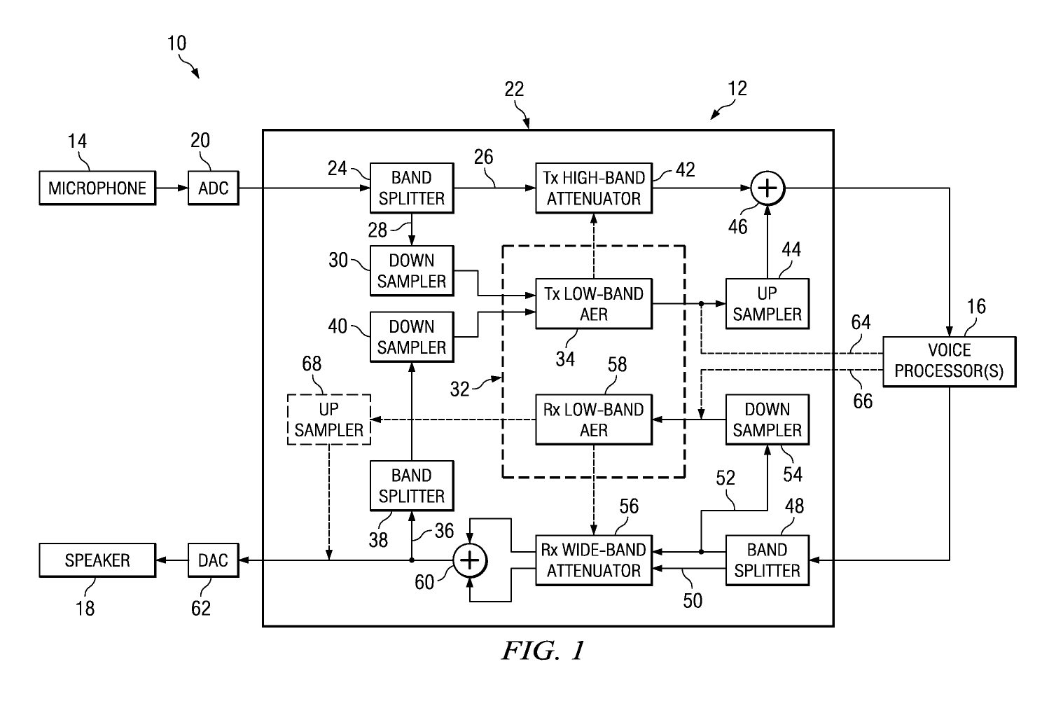

FIG. 1 illustrates an example of a voice communication device 10 in accordance with an aspect of the invention. The voice communication device 10 can be any of a variety of voice communication devices, such as a wireless phone, voice-over-IP (VoIP) phone, or conferencing device. The voice communication device 10 includes an AER system 12 that interconnects a microphone 14, one or more voice processors 16, and a speaker 18. The voice processor(s) 16 can he and/or include any of a variety of voice processing devices, such as a vocoder and/or voice packetizer. The microphone 14 collects audio data from a near-end user that is to be processed by the voice processor(s) 16 and transmitted from the voice communication device 10. Thus, the path from the microphone 14 to the voice processor(s) 16, passing through the AER system 12, is defined as a transmit path. Likewise, data that is received fey the voice communication device 10 is processed by the voice processor(s) 16 and communicated to the near-end user via the speaker 18. Thus, the path from the voice processor(s) 16 to the speaker 18, passing through the AER system 12, is defined as a receive path. The AER system 12 is configured to mitigate acoustic echo in a transmit signal in the transmit path and/or a receive signal in the receive path.

In the example of FIG. 1, the transmit signal originates at the microphone 14. The analog data in the transmit signal can have a frequency of up to approximately 8000 Hz. The transmit signal is converted from an analog signal to a digital signal at an analog-to-digital converter (ADC) 20. The ADC 20 can output samples of the transmit signal at a sample frequency of approximately 16 kHz. It is to be understood that, for the example of a 16 kHz sample frequency, 8 kHz is a Nyquist rate and a maximum spectral content frequency of the transmit signal. However, the ADC 20 can output samples at a sample frequency that is higher than 16 kHz for an 8 kHz transmit signal, for example, 32 kHz. The transmit signal is then input to an AER shell 22 of the AER system 12.

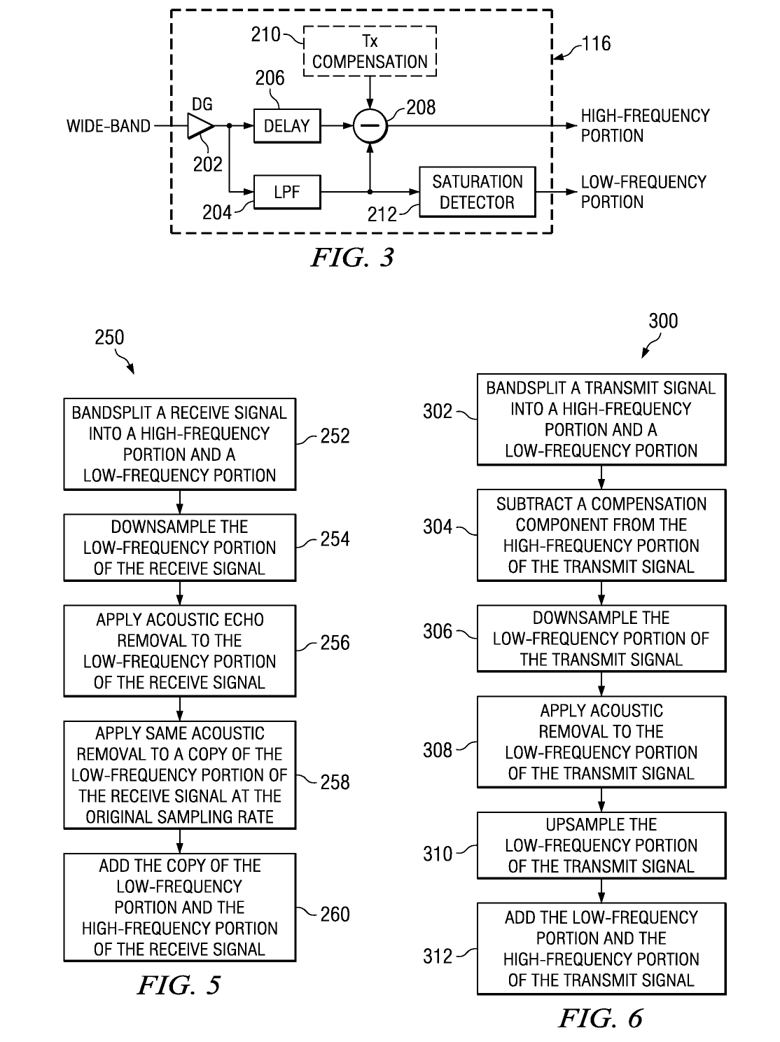

Upon being input to the AER shell 22, the transmit signal can be bandsplit by a transmit-path bandsplitter 24. The bandsplitter 24 can separate the transmit signal into a high-frequency portion, designated at 26, and a low-frequency portion, designated at 28. For example, the low-frequency portion of the transmit signal can have a frequency that is less than or equal to 3400 Hz, and the high-frequency portion of the transmit signal can have a frequency that is substantially between 3400 Hz and 8000 Hz. The bandsplitter 24 can, for example, employ a low-pass filter (LPF) to generate the low-frequency portion of the transmit signal. However, the high-frequency portion of the transmit signal can be mathematically derived based on the low-frequency portion of the transmit signal, as will be described in greater detail in the example of FIG. 3 below. Such an arrangement can provide a more efficient and more accurate separation of the high and low-frequency portions of the transmit signal. In addition, the bandsplitter 24 can also include a saturation detector to detect when saturation is introduced to the low-frequency portion of the transmit signal based on a transient overflow from the LPF operation.

The low-frequency portion 28 of the transmit signal is input to a downsampler 30. The downsampler 30 reduces the sample frequency of the low-frequency portion of the transmit signal. As an example, the downsampler 30 can reduce the sample frequency of the low-frequency portion of the transmit signal in half, such as, for example, from 16 kHz to 8 kHz. For example, the downsampler 30 can remove every other digital sample from the low-frequency portion of the transmit signal to achieve the downsampling operation. The downsampled low-frequency portion of the transmit signal is output from the downsampler 30 and input to an AER core 32.

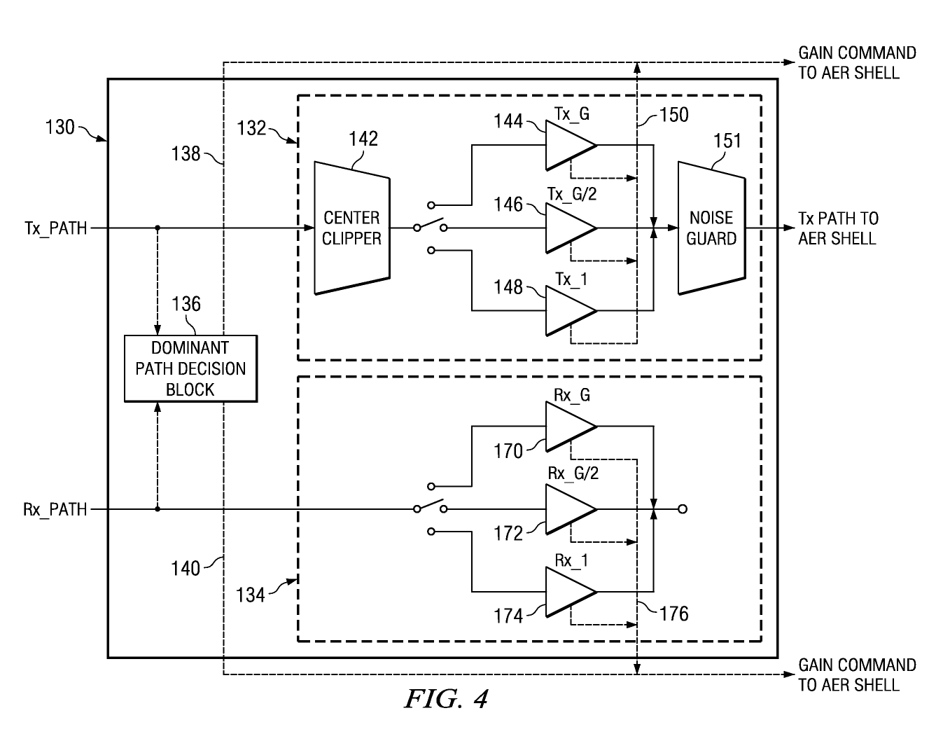

The AER core 32 includes a transmit-path low-band acoustic echo remover (hereinafter “Tx low-band AER”) 34. The Tx low-band AER 34 can employ acoustic echo cancellation and/or acoustic echo suppression to the low-frequency portion of the transmit signal. For example, as demonstrated in the example of FIG. 1, the Tx low-band AER 34 can input a downsampled low-frequency portion of an attenuated receive-path signal 36, via a bandsplitter 38 and a downsampler 40, to perform acoustic echo cancellation by subtracting linearly predicted acoustic echo associated with the attenuated receive-path signal 36 from the low-frequency portion of the transmit signal. In addition, the Tx low-band AER 34 can apply an amount of attenuation to the low-frequency portion of the transmit signal based on a determination by the AER core 32 of whether the transmit signal or the receive signal is a dominant signal, as will be described in greater detail below in the example of FIG. 4.

The low-frequency portion of the transmit signal includes the frequency range of typical person-to-person conversation. As such, performing acoustic echo cancellation and/or suppression on the low-frequency portion of the transmit signal yields the most effective results for the removal of acoustic echo. In addition, because the acoustic echo cancellation and/or suppression is performed on the low frequency band at the downsampled frequency rate, the removal of acoustic echo by the Tx low-band AER 34 is more efficient as it requires less machine instructions per second (MIPS).

The high-frequency portion of the transmit signal can be included in the voice communication device 10 to provide better audio quality for the respective far-end user. Performing acoustic echo cancellation on the high-frequency portion of the transmit signal may not provide significant improvements in audio quality, and can thus provide diminishing returns on account of the significant increase in the number of MIPS that would be required for such an operation. However, acoustic echo suppression can be employed on the high-frequency portion of the transmit signal with minimal detriment to operational efficiency of the voice communication device 10. As such, the Tx low-band AER 34, upon determining an amount of attenuation to apply to the low-frequency portion of the transmit signal, can communicate the same attenuation amount to a Tx high-band attenuator 42. The Tx high-band attenuator 42 can thus perform the same amount of attenuation to the high-frequency portion of the transmit signal. In addition, the Tx low-band AER 34, upon the AER core 32 determining that the receive signal is the dominant signal, can command the Tx high-band attenuator 42 to completely attenuate the high-frequency portion of the transmit signal. As such, the Tx high-hand attenuator 42 can provide an infinite attenuation gain to the high-frequency portion of the transmit signal, such that, for example, the high-frequency portion of the transmit signal is output from the Tx high-band attenuator 42 as a string of digital zeros.

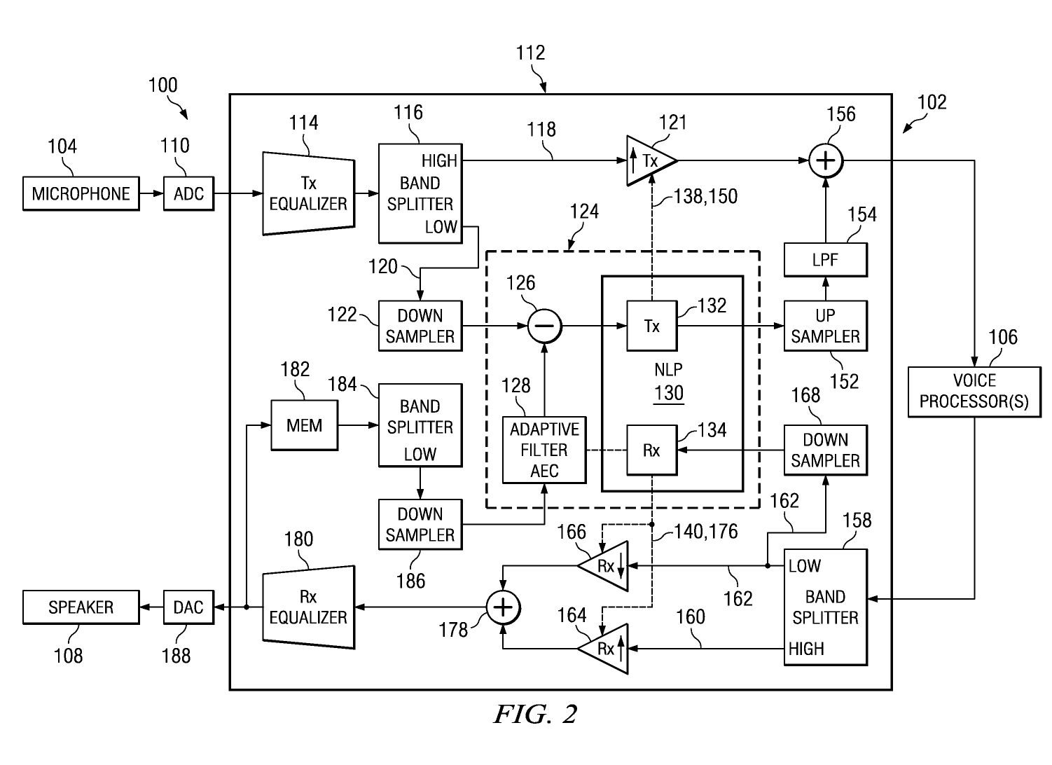

The low-frequency portion of the transmit signal, upon being output from the Tx low-band AER 34 in the AER core 32 is input to an upsampler 44. The upsampler 44 increases the sample frequency of the low-frequency portion of the transmit signal back to the sample frequency of the AER shell 22 (e.g., 16 kHz). For example, the upsampler 44 can insert a digital zero between every other digital sample from the low-frequency portion of the transmit signal to achieve the upsampling operation. The Tx low-band AER 34 may also output a downsampled low-frequency portion of the transmit signal directly to the voice processor(s) 16, as will be demonstrated in the example of FIG. 2 below. In addition, it is to be understood that the upsampling operation of the upsampler 44 requires additional MIPS, and thus introduces a delay in the processing of the transmit signal. For example, the upsampler 44 can delay processing of the transmit signal by approximately 1 millisecond.

The low-frequency portion of the transmit signal output from the upsampler 44 and the high-frequency portion of the transmit signal output from the Tx high-band attenuator 42 are each input to an adder 46. The adder 46 adds the low-frequency portion of the transmit signal to the high-frequency portion of the transmit signal to generate an attenuated transmit signal. The attenuated transmit signal can he substantially free from acoustic echo as a result of the acoustic echo cancellation and/or acoustic echo suppression performed by the Tx low-band AER 34 and the Tx high-band attenuator 42. In addition, a compensation component may have been subtracted from the high-frequency portion of the transmit signal in the bandsplitter 24, such that the attenuated transmit signal can be substantially free of distortion that was introduced into the low-frequency portion of the transmit signal. As a result, the attenuated transmit signal is a substantially identical reconstruction of the transmit signal that was input to the AER shell 22 from the ADC 20. The attenuated transmit signal is thus output from the AER shell 22 and input into the voice processor(s) 16, such that it can be modulated, converted to analog, and transmitted from the voice communication device 10.

In the example of FIG. 1, the receive signal originates at the voice processor(s) 16. For example, the voice communication device 10 can receive a voice receive signal from a digital packet network, and is output from the voice processor(s) 16 to the AER shelf 22. As it is input to the AER shelf 22, the receive signal may have spectral content having a frequency of up to approximately 8000 Hz. As such, samples of the receive signal are input to the AER shell at a sample frequency of approximately 16 kHz, it is to be understood that, for the example of a 16 kHz sample frequency, 8 kHz is a Nyquist rate and a maximum spectral content frequency of the receive signal. However, for some voice communication applications, the sample frequency of the receive signal can be higher than 16 kHz (e.g., 32 kHz).

Upon being input to the AER shell 22, the receive signal can be bandsplit by a receive-path bandsplitter 48. The bandsplitter 43 can separate the receive signal info a high-frequency portion, designated at 50, and a low-frequency portion, designated at 52. For example, the low-frequency portion of the receive signal can have a frequency that is less than or equal to 3400 Hz, and the high-frequency portion of the receive signal can have a frequency that is substantially between 3400 Hz and 8000 Hz. The bandsplitter 48 can employ an LPF to generate the low-frequency portion 52 of the receive signal. However, the high-frequency portion 50 of the receive signal can be mathematically derived based on the low-frequency portion 52 of the receive signal, as will be described in greater detail in the example of FIG. 3 below. Such an arrangement can provide a more efficient and more accurate separation of the high and low-frequency portions of the receive signal. In addition, the bandsplitter 48 can also include a saturation detector to defect when saturation is introduced to the low-frequency portion of the receive signal based on a transient overflow from the LPF operation. The bandsplitter 48 outputs the low-frequency portion 52 of the receive signal to a downsampler 54. The bandsplitter 48 outputs the high-frequency portion 50 of the receive signal, as well as a copy of the low-frequency portion 52 of the receive signal, to an Rx wide-band attenuator 56.

The downsampler 54 reduces the sample frequency of the low-frequency portion of the receive signal. As an example, the downsampler 54 can reduce the sample frequency of the low-frequency portion of the receive signal in half, such as, for example, from 16 kHz to 8 kHz. For example, the downsampler 54 can remove every other digital sample from the low-frequency portion of the receive signal to achieve the downsampling operation. The downsampled low-frequency portion of the receive signal is output from the downsampler 64 and input to the AER core 32.

The AER core 32 includes a receive-path low-band acoustic echo remover (hereinafter “Rx low-band AER”) 58. The Rx low-band AER 58 can employ acoustic echo suppression to the low-frequency portion of the receive signal. For example, the Rx low-band AER 58 can apply an amount of attenuation to the low-frequency portion of the receive signal based on a determination by the AER core 32 of which of the transmit signal and the receive signal is a dominant signal, as will be described in greater detail below in the example of FIG. 4. Similar to that described above for the transmit signal, performing acoustic echo suppression on the low-frequency portion of the receive signal yields the most effective results for the removal of acoustic echo, as well as the most efficient due to the requirement of less MIPS.

The high-frequency portion of the receive signal can be included in the voice communication device 10 to provide better audio quality for the respective near-end user. As such, the Rx low-band AER 58, upon determining an amount of attenuation to apply to the low-frequency portion of the receive signal, can communicate the attenuation amount to the Rx wide-band attenuator 56. The Rx wide-band attenuator 56 can thus perform the same amount of attenuation to both the high-frequency portion of the receive signal and the copy of the low-frequency portion of the receive signal at the sampling rate of the AER shell 22. In addition, the Rx low-band AER 58, upon the AER core 32 determining that the receive signal is the dominant signal, can command the Rx wide-band attenuator 56 to completely attenuate the high-frequency portion of the receive signal. As such, the Rx wide-band attenuator 56 can provide an infinite attenuation gain to the high-frequency portion of the receive signal, such that, for example, the high-frequency portion of the receive signal is output from the Rx high-band attenuator 56 as a string of digital zeros.

As described above, the copy of the low-frequency portion of the receive signal is attenuated the same as the low-frequency portion of the receive signal in the AER core 22. As such, the copy of the low-frequency portion of the receive signal and the low-frequency portion of the receive signal are substantially identical signals at different sampling rates. The copy of the low-frequency portion of the receive signal and the high-frequency portion of the receive signal output from the Rx wide-band attenuator 56 are each input to an adder 60. The high-frequency portion of the receive signal and the copy of the low-frequency portion of the receive signal can be readily added together because they are sampled at the same sampling rate. Thus, the adder 60 adds the copy of the low-frequency portion of the receive signal to the high-frequency portion of the receive signal to generate the attenuated receive signal 36. Acoustic echo resulting from the receive signal can be substantially mitigated as a result of the acoustic echo suppression performed by the Rx wide-band attenuator 56, based on the acoustic echo suppression performed on the low-frequency portion of the receive signal by the Rx low-band AER 58. Because the attenuated receive signal 36 is the sum of the high-frequency portion of the receive signal and the copy of the low-frequency portion of the receive signal, the low-frequency portion of the receive signal that is attenuated in the Rx low-band AER 58 need not be upsampled to generate the attenuated receive signal 36. Therefore, processing delays associated with upsampling the low-frequency portion of the receive signal to generate the attenuated receive signal 36 are substantially eliminated. Accordingly, the example of FIG. 1 demonstrates an efficient removal of acoustic echo in the receive path of the voice communication device 10.

As described above regarding the transmit path, the attenuated receive signal 36 is input to the bandsplitter 38 to provide a low-frequency portion of the attenuated receive signal 36, which is downsampled by the downsampler 40 and input to the Tx low-band AER 34 to provide acoustic echo cancellation to the low-frequency portion of the transmit signal. In addition, the attenuated receive signal 36 is input to a digital-to-analog converter (DAC) 62. The DAC 62 converts the digital attenuated receive signal into an analog form and the analog receive signal is output to the speaker 18. It is to be understood that, in addition to mitigation of acoustic echo resulting from the receive signal, the attenuation of the receive signal may result in the respective near-end user hearing the received data substantially free from acoustic echo originating from a far-end voice communication device.

As described above, a low-frequency portion of voice signals (e.g., 4 kHz) includes the frequency range of typical person-to-person conversation. The above implementation of a wide-band (e.g., 8 kHz) thus provides a more enhanced voice quality for a given call. However, some voice processing implementations can still operate solely at a low-frequency voice signal range. As such, the AER system 12 can be configured to switch between a wide-band mode, as described in the above implementation, and a low-band mode, as described below. The switching between the wide-band mode and the low-band mode can occur, for example, based on a manual or automatic selection, such as via a software/firmware selection or a hardware selection (e.g., one or more dip switches).

In the low-band mode, the Tx low-band AER 34 can be configured to output a downsampled low-frequency portion of the transmit signal directly to the voice processor(s) 16. The downsampled low-frequency portion of the transmit signal is demonstrated in the example of FIG. 1 at 64. For example, one or more of the voice processors(s) 16 may be configured to process 4 kHz voice signals. As such, by providing the downsampled low-frequency portion of the transmit signal directly to the voice processor(s) 16, the voice processor(s) 16 do not require an additional downsampler external to the AER system 12. Thus, implementation of the low-band mode may bypass the operation of the bandsplitter 24, the Tx high-band attenuator 42, the upsampler 44, and the adder 46. It is to be understood that these components could be deactivated by switching to the low-band mode, or could continue to operate regardless of the mode to which the AER system 12 is switched.

It is to be understood that, in the wide-band mode, the Tx low-band AER 34 can output the downsampled low-frequency portion of the transmit signal directly to the voice processor(s) 16 in addition to the upsampler 44. For example, depending on the application of the voice communication device 10, a low-frequency portion of the transmit signal sampled at, for example, 8 kHz may be used for any of a variety of purposes in one or more of the voice processor(s) 16. As an example, a tone defection unit (not shown) may operate more efficiently at a sampling rate of 8 kHz. As another example, the voice communication device 10 can communicate with a number of far-end users, such as in a conference call, with one or more of the multiple far-end users operating with an 8 kHz sampling rate voice processor.

Similar to as described above, in the low-band mode, the AER system 12 can be configured to receive a 4 kHz receive signal from the voice processor(s) 16 at 8 kHz sampling rate. The low-frequency portion of the receive signal is demonstrated in the example of FIG. 1 at 66. For example, one or more of the voice processor(s) 16 may he configured to process 4 kHz voice signals. As such, by providing a low-frequency portion of the receive signal to the voice AER system 12, the voice processor(s) 16 do not require an additional upsampler in providing the receive signal to the AER system 12. Thus, implementation of the low-band mode may bypass the operation of the bandsplitter 48, the Rx wide-band attenuator 56, and the adder 60. Instead, the Rx low-band AER can provide a low-frequency portion of the receive signal to an upsampler 68, which can upsample the low-frequency portion of the receive signal and provide the upsampled receive signal to the DAC 62. Thus, the speaker 18 can still provide 8 kHz audio signals. It is to be understood that the bandsplitter 48, the Rx wide-band attenuator 56, and the adder 60 could be deactivated by switching to the low-band mode, or could continue to operate regardless of the mode to which the AER system 12 is switched.

Based on the switchability of the AER system 12, the AER system 12 can be included in any of a variety of voice communication devices, regardless of the frequency of voice processing performed by a given one or more voice processors 16. For example, the switchability of the AER system 12 can be such that the AER core 32 can be implemented as a standard component, regardless of external frequencies. Thus, the AER system 12 is configured to flexibly provide acoustic echo removal in any of a variety of voice applications.

It is to be understood that FIG. 1 demonstrates but one example of a voice communications device having acoustic echo removal in accordance with an aspect of the invention. As such, the voice communication device 10 is not intended to be limited to the example of FIG. 1. For example, as will be demonstrated in the example of FIG. 2 below, additional components can be included in the AER system 12 in the voice communication device 10 in the example of FIG. 1.

FIG. 2 illustrates an example of a voice communication device 100 in accordance with an aspect of the invention. The voice communication device 100 includes an AER system 102 that interconnects a microphone 104, one or more voice processor(s) 106, and a speaker 108. It is to be understood that the example of FIG. 2 is intended to represent operation of the AER system 102 in a wide-band mode, similar to as described above in the example of FIG. 1. However, it is to be understood that the AER system 102 is not intended to be limited to operation in the wide-band mode, but can be switchably configured to operate in a low-band mode, as well, similar to as described above in the example of FIG. 1.

The microphone 104 collects audio data from a near-end user that is to be processed by the voice processor(s) 106 and transmitted from the voice communication device 100. Thus, the path from the microphone 104 to the voice processor(s) 106, passing through the AER system 102, is defined as a transmit path. Likewise, data that is received by the voice communication device 100 is processed by the voice processor(s) 106 and communicated to the near-end user via the speaker 108. Thus, the path from the voice processor(s) 106 to the speaker 108, passing through the AER system 102, is defined as a receive path. The AER system 102 is configured to mitigate acoustic echo in a transmit signal in the transmit path and/or a receive signal in the receive path.

In the example of FIG. 2, the transmit signal originates at the microphone 104. The analog data in the transmit signal can have a frequency of up to approximately 8000 Hz. The transmit signal is converted from an analog signal to a digital signal at an ADC 110. The ADC 110 can output samples of the transmit signal at a sample frequency of approximately 16 kHz. It is to be understood that, for the example of a 16 kHz sample frequency, 8 kHz is a Nyquist rate and a maximum spectral content frequency of the transmit signal. However, the ADC 110 can output samples at a sample frequency that is higher than 16 kHz for an 8 kHz transmit signal. The transmit signal is then input to an AER shell 112 of the AER system 102.

Upon being input to the AER shell 112, the transmit signal is input to a transmit-path equalizer 114. The transmit path equalizer 114 is configured to filter and compensate for distortion and/or noise present in the transmit signal resulting from the microphone 104. The transmit signal is then input to a transmit-path bandsplitter 116. The bandsplitter 116 can separate the transmit signal into a high-frequency portion, designated at 118, and a low-frequency portion, designated at 120.

FIG. 3 illustrates an example of the bandsplitter 116 in accordance with an aspect of the invention. The bandsplitter 116 receives a wide-band signal as an input and generates a low-frequency portion output and a high-frequency portion output. The wide-band signal can have spectral content within a frequency bandwidth of between 0 and 8000 Hz. The wide-band signal is input to a digital gain amplifier 202. The digital gain amplifier 202 can be configured to provide a digital gain that is a normalization constant, such as 0.98. For example, the normalization constant can be such as to mitigate undesirable excess ripple in sine wave components of the wide-band signal, such that the gain of the transfer function of the bandsplit outputs does not exceed unity.

The wide-band signal is output from the digital gain amplifier 202 and is input to a low-pass filter (LPF) 204. The LPF 204 can have a threshold frequency of 3400 Hz, such that the LPF 204 outputs the low-frequency portion of the wide-band signal that is less than or equal to 3400 Hz. The wide-band signal is also output from the digital gain amplifier 202 to a delay element 206 that has a delay time approximately equal to a delay associated with the LPF 204. Accordingly, the LPF 204 and the delay element 206 are configured to ensure that they each output the respective output signals substantially concurrently.

The low-frequency signal output from the LPF 204 and the wide-band signal output from the delay element 206 are each input to a subtractor 208. The subtractor 208 subtracts the low-frequency portion of the wide-band signal from the wide-band signal itself. Thus, the subtractor 208 outputs a high-frequency portion of the wide-band signal that is substantially the wide-band signal minus the low-frequency portion of the wide-band signal. For example, as described above, the low-frequency portion of the wide-band signal may have a frequency that is less than or equal to 3400 Hz. Therefore, the high-frequency portion of the wide-band signal can have a frequency that is approximately between 3400 Hz and 8000 Hz.

Such a configuration to determine the high-frequency portion and the low-frequency portion of the wide-band signal can be a more efficient and more accurate way to provide bandsplitting for the wide-band signal, as opposed to using both an LPF and a high pass filter (HPF) to bandsplit the wide-band signal. For example, by mathematically deriving the high-frequency portion of the wide-band signal based on the low-frequency portion of the wide-band signal, potential digital signal processing round-off errors can be significantly reduced, thus resulting in a more accurate representation of the total wide-band signal based on the respective high frequency and low-frequency portions. In addition, concurrent use of separate LPFs and HPFs can result in additional MIPS, thus introducing additional undesirable delays.

The bandsplitter 116 can also include a transmit-path compensation element 210. The transmit-path compensation element 210 can be included in the transmit-path bandsplitter, such as the bandsplitter 116 in the example of FIG. 2. The transmit-path compensation element 210 can be input to the subtractor 208, such that a compensation component can also be subtracted from the wide-band signal for the generation of the high-frequency portion of the transmit signal. The compensation component can include distortion associated with at least one of normalization, downsampling, upsampling, and low-pass filtering of the low-frequency portion of the transmit signal. Accordingly, upon subsequently adding the distorted low-frequency portion of the transmit signal to the high-frequency portion of the transmit signal, the resultant attenuated transmit signal is a substantially identical reconstruction of the original transmit signal. It is to be understood that the subtraction of the compensation component can result in additional MIPS, such that the implementation of the transmit-path compensation component 210 can provide an attenuated transmit signal that is substantially free from distortion at the possible expense of additional unwanted signal delay. It is also to be understood that the subtractor 208 could be configured to subtract the distortion introduced by the transmit-path compensation component 210 only in response to the transmit-path being determined as the dominant signal path, as described below.

The bandsplitter 116 also includes a saturation detector 212 configured to detect when saturation is introduced to the low-frequency portion of the transmit signal based on the downsampling operation. For example, the saturation defector 212 can defect when transient components of the low-frequency portion of the signal provide overflow based on the filtering operation of the LPF 204. In response to detecting saturation of the low-frequency portion of the signal the saturation detector 212 can report the presence of saturation to the acoustic echo removal components, as will be described below. The high-frequency component of the wide-band signal and the low-frequency component of the wide-band signal are then output from the bandsplitter 116.

It is to be understood that the configuration of the bandsplitter 116 in the example of FIG. 3 may not be limited to the bandsplitter 116 in the transmit path of the AER system 102. For example, the example of FIG. 3 could also be implemented in one or both of bandsplitters 158 and 184, as will be described below. However, it is to be understood that the possible inclusion of the transmit-path compensation component may be specific solely to the transmit path.

Referring back to FIG. 2, the high-frequency portion of the transmit signal is input to a digital gain amplifier 121. The digital gain amplifier 121 provides a variable amount of attenuation to the high-frequency portion of the transmit signal, as is discussed in greater detail in the example of FIG. 4 below. The low-frequency portion 120 of the transmit signal is input to a downsampler 122. The downsampler 122 reduces the sample frequency of the low-frequency portion of the transmit signal. As an example, the downsampler 122 can reduce the sample frequency of the low-frequency portion of the transmit signal in half, such as, for example, from 16 kHz to 8 kHz. For example, the downsampler 122 can remove every other digital sample from the low-frequency portion of the transmit signal to achieve the downsampling operation. For a sampling rate of 8 kHz, the Nyquist frequency is 4000 Hz. The frequency of the low-frequency portion of the transmit signal, however, is 3400 Hz, which is less than the Nyquist frequency by 600 Hz. Because the low-frequency portion of the transmit signal has a frequency that is less than the Nyquist frequency, the low-frequency portion of the transmit signal has better anti-aliasing protection than a signal having a frequency that is at or more substantially near the Nyquist frequency. Therefore, the downsampler 122 can provide more accurate samples of the low-frequency portion of the transmit signal at the 8 kHz sampling rate than a signal that is at or more substantially near the Nyquist frequency.

As described above, the low-frequency portion of the transmit signal includes the frequency range of typical person-to-person conversation. As such, performing acoustic echo cancellation and/or suppression on the low-frequency portion of the transmit signal at the downsampled frequency rate (e.g., 8 kHz) yields the most effective results for the removal of acoustic echo. In addition, because the acoustic echo cancellation and/or suppression is performed on the low frequency band at the downsampled frequency rate, the removal of acoustic echo by the AER core 124 is more efficient as it requires less MIPS.

The AER core 124 includes a subtractor 126 that receives the downsampled low-frequency portion of the transmit signal as an input. The subtractor 126 is also coupled to an adaptive filter acoustic echo canceller (AEC) 128. The adaptive filter AEC 128 receives samples that may include acoustic echo components from the receive path, adaptively filters the samples, such that it linearly predicts acoustic echo in the transmit signal, and outputs the samples to the subtractor 126. The samples from the receive path are substantially correlated with the samples of tie low-frequency portion of the transmit signal such that the subtractor 126 subtracts linearly predicted acoustic echo associated with the adaptively filtered receive path samples from the low-frequency portion of the transmit signal. Accordingly, the adaptive filter AEC 128 and the subtractor 126 jointly perform acoustic echo cancellation on the low-frequency portion of the transmit signal. The low-frequency portion of the transmit signal is then input to a non-linear processor (NLP) 130. The NLP 130 includes a transmit component 132 and a receive component 134.

FIG. 4 illustrates an example of the NLP 130 in accordance with an aspect of the invention. It is to be understood that like reference numbers will be used in the discussion of FIG. 4 as those used in the example of FIG. 2. The low-frequency portion of the transmit signal, designated as Tx_PATH in the example of FIG. 4, is input to the NLP 130. Likewise, a low-frequency portion of the receive signal, designated as Rx_PATH in the example of FIG. 4, is also input to the NLP 130. Both Tx_PATH and Rx_PATH are monitored by a dominant path decision block 136. The dominant path decision block 136 compares a relative signal strength of the low-frequency portions of both the transmit signal and the receive signal. Upon determining which of the transmit signal and the receive signal has the highest signal strength, the dominant path decision block 136 assigns the strongest signal as the dominant signal and the weakest signal as the non-dominant signal. The dominant path decision block 136 then communicates a gain command to the AER shell 112. For example, the gain command could be infinite attenuation, such as a string of digital zeros, to the high-frequency portion of the non-dominant signal, such that the high-frequency portion of the non-dominant signal becomes completely attenuated. Thus, in the example of FIG. 4, the dominant path decision block 136 can communicate the gain command for a dominant receive signal to the AER shell 112 at 138, and can communicate the gain command for a dominant transmit signal to the AER shell 112 at 140. As such, acoustic echo can be mitigated by attenuating the high-frequency portion of the non-dominant one of the transmit signal and the receive signal.

It is to be understood that the dominant path decision block 136 can be configured to determine that neither the transmit path nor the receive path is dominant For example, in the case of double-talk, such as when both a near-end user and a far-end user are communicating simultaneously, the relative signal strengths of the transmit signal and the receive signal may be very close or substantially equal. As such, dominant path decision block 136 can be programmed in a variety of ways to respond to a double-talk condition. For example, the dominant path decision block 136 can completely attenuate either both or one of the high-frequency portions of the transmit and receive signals. As another example, the dominant path decision block can provide relative variable amounts of attenuation to each of the high-frequency portions of the transmit and receive signals, such as in response to one of the signal strengths of the transmit and receive signals being marginally greater than the other. Furthermore, the dominant decision path block 140 can have a fixed or adjustable threshold that determines when to apply a dominant signal condition versus a double-talk condition.

The dominant path decision block 136 may also include a timing component for the switching of path dominance. For example, because a high-frequency portion of a given transmit or receive signal may be completely attenuated upon the given transmit or receive signal being non-dominant, an instantaneous switching of dominance could result in a rapid change of signal gain. As a result, either the near-end or the far-end communication device could receive an undesirable audible speaker “pop” or rapid volume change. As such, the timing component of the dominant path decision block 136 can provide gradual attenuation gain coordination of the high-frequency portions of the transmit signal and the receive signal during a signal dominance transition. For example, the dominant path decision block 136 can be programmed with a predetermined time, such as, for example, 10 milliseconds. Upon a transition of the transmit signal from non-dominant to dominant, the high-frequency portion of the now non-dominant receive signal can become gradually completely attenuated over the course of the predetermined time. Likewise, the high-frequency portion of the now dominant transmit signal can gradually change from being completely attenuated to having an attenuation amount that is the same as the respective low-frequency portion, as is described below. Such changes in attenuation between the high-frequency portions of the transmit signal and the receive signal can occur substantially concurrently over the predetermined time or can occur sequentially.

The signal Tx_PATH is also input to a center dipper 142 in the transmit component 132 of the NLP 130. The center clipper 142 provides attenuation of the low-frequency portion of the transmit signal upon the low-frequency portion of the transmit signal not exceeding an amplitude threshold. The amplitude threshold, for example, can be centered at zero. As such, acoustic echo can be further reduced as a transmit signal that includes only acoustic echo may not have a sufficient signal strength to exceed the amplitude threshold of the center clipper 142, and is thus attenuated.

Upon being output from the center clipper 142, the low-frequency portion of the transmit signal is switched to one of a plurality of digital gain amplifiers 144, 146, and 148. The digital gain amplifier 144 can apply an attenuation gain of G to the low-frequency portion of the transmit signal, where G is greater than zero and corresponds to units of decibels (dB). The digital gain amplifier 146 can apply an attenuation gain of G/2 to the low-frequency portion of the transmit signal. The digital gain amplifier 148 can apply an attenuation gain of 0 dB to the low-frequency portion of the transmit signal, such that, in the example of FIG. 4, the digital gain amplifier 148 applies unity gain. The switching of the low-frequency portion of the transmit signal can occur based on which of the transmit and receive signals is the dominant signal. Additionally, the timing component of the dominant path decision block 136 can switch the low-frequency portion of the transmit signal gradually over the predetermined time upon a dominant signal transition.

As an example, upon the receive signal being the dominant signal, the low-frequency portion of the transmit signal can be switched to the digital gain amplifier 144, such that the low-frequency portion of the transmit signal is attenuated by a factor of G. As another example, upon a double-talk condition, wherein neither the receive signal nor the transmit signal is dominant, the low-frequency portion of the transmit signal can be switched to the digital gain amplifier 146, such that the low-frequency portion of the transmit signal is attenuated by a factor of G/2. As yet another example, upon the transmit signal being the dominant signal, the low-frequency portion of the transmit signal can be switched to the digital gain amplifier 148, such that the low-frequency portion of the transmit signal is not attenuated due to the application of unity gain (e.g., 0 dB) by the digital gain amplifier 148.

In addition, under certain circumstances, upon the saturation defector 212 of the bandsplitter 116 detecting saturation of the low-frequency portion of the transmit signal based on a transient overflow from the LPF operation, the saturation detector 212 can communicate with the transmit portion 132 of the NLP 130 to increase the attenuation gain applied to the low-frequency portion of the transmit signal. For example, the transmit portion 132 of the NLP 130 can switch the low-frequency portion of the transmit signal to a digital gain amplifier having a larger attenuation gain. As another example, the transmit portion 132 of the NLP 130 can increase the value of the attenuation gain factor G in response to the defection of saturation in the low-frequency portion of the transmit signal.

Similar to that described above in the example of FIG. 1, the high-frequency portion of the transmit signal can be included in the voice communication device 100 to provide better audio quality for the respective far-end user. Performing acoustic echo cancellation on the high-frequency portion of the transmit signal may not provide significant improvements in audio quality, and can thus provide diminishing returns on account of the significant increase in the number of MIPS that would be required for such an operation. However, acoustic echo suppression can be employed on the high-frequency portion of the transmit signal with minimal detriment to operating efficiency of the voice communication device 100.

Upon attenuating the low-frequency portion of the transmit signal, the transmit component 132 of the NLP 130 communicates the attenuation amount that was applied to the low-frequency portion of the transmit signal to the digital gain amplifier 121 in the AER shell 112 in the example of FIG. 2, as indicated at 150. Specifically, the amount of attenuation that is applied to the low-frequency portion of the transmit signal by the respective one of the digital gain amplifiers 144, 146, and 148 is likewise applied to the high-frequency portion of the transmit signal at the digital gain amplifier 121. However, as described above, it is to be understood that the digital gain amplifier 121 can completely attenuate the high-frequency portion of the transmit signal upon the receive signal being the dominant signal, as dictated by the dominant path decision block 136. Thus, the digital gain amplifier 121 applies substantially the same attenuation gain as the respective one of the digital gain amplifiers 144, 146, and 148 upon the transmit signal being determined as the dominant signal.

The low-frequency portion of the transmit signal is output from the respective one of the digital gain amplifiers 144, 146, and 148 to a noise guard 151. The noise guard 151 can filter noise from the low-frequency portion of the transmit signal that results from the application of the digital gain from the respective one of the digital gain amplifiers 144, 146, and 148. The low-frequency portion of the transmit signal is then output from the NLP 130 back to the AER shell 112.

It is to be understood that the NLP 130 is not limited to the example of FIG. 40. For example, the low-frequency portion of the transmit signal could be switched between more than just three digital gain amplifiers based on, for example, varying relative differences between signal strengths of the low-frequency portions of the transmit and receive signals. As another example, the digital gain amplifiers 144, 146, and 148 could apply different digital gain amounts than G, G/2, and 0 dB, respectively, such that the gain amounts may not be linear with respect to each other.

Referring back to FIG. 2, the low-frequency portion of the transmit signal, upon being output from the transmit component 132 of the NLP 130 in the AER core 124 is input to an upsampler 152. The upsampler 152 increases the sample frequency of the low-frequency portion of the transmit signal back to the sample frequency of the AER shell 112 (e.g., 16 kHz). For example, the upsampler 152 can insert a digital zero between every other digital sample from the low-frequency portion of the transmit signal to achieve the upsampling operation. As described above in the example of FIG. 1, if is to be understood that the upsampling operation of the upsampler 152 requires additional MIPS, and thus introduces a delay in the processing of the transmit signal. For example, the upsampler 152 can delay processing of the transmit signal by approximately 1 millisecond.

The upsampled low-frequency portion of the transmit signal is input to an LPF 154, which provides low-pass filtering of the low-frequency portion of the transmit signal. The low-frequency portion of the transmit signal output from the LPF 154 and the high-frequency portion of the transmit signal output from the digital gain amplifier 121 are each input to an adder 156. The adder 156 adds the low-frequency portion of the transmit signal to the high-frequency portion of the transmit signal to generate an attenuated transmit signal. The attenuated transmit signal can be substantially free from acoustic echo as a result of the acoustic echo cancellation and acoustic echo suppression performed in the AER core 124 and the digital gain amplifier 121. In addition, because a compensation component was subtracted from the high-frequency portion of the transmit signal by the transmit-path compensation element 210 in the bandsplitter 116, the attenuated transmit signal can be substantially free of distortion that was introduced info the low-frequency portion of the transmit signal. As a result, the attenuated transmit signal is a substantially identical reconstruction of the transmit signal that was input to the bandsplitter 116. The attenuated transmit signal is thus output from the AER shell 112 and input to the voice processor(s) 106, such that it can be modulated, converted to analog, and transmitted from the voice communication device 100.

In the example of FIG. 2, the receive signal originates at the voice processor(s) 106. For example, the voice communication device 100 can receive a voice receive signal from a digital packet network, and is provided from the voice processor(s) 106 to the AER shell 112. As it is input to the AER shell 112, the receive signal may have spectral content at a frequency of up to approximately 8000 Hz. As such, samples of the receive signal are input to the AER shell 112 at a sample frequency of approximately 16 kHz. It is to be understood that for the example of a 16 kHz sample frequency, 8 kHz is a Nyquist rate and a maximum spectral content frequency of the receive signal. However, the sample frequency of the receive signal can be higher than 16 kHz.

Upon being input to the AER shell 112, the receive signal can be bandsplit by a receive-path bandsplitter 158. The bandsplitter 158 can separate the receive signal info a high-frequency portion, designated at 160, and a low-frequency portion, designated at 162. The bandsplitter 158 can be implemented in a similar manner as the bandsplitter 116 in the example of FIG. 3. Specifically, the low-frequency portion of the receive signal may generated from an LPF, such as the LPF 204 in the example of FIG. 3, and the high-frequency portion of the receive signal may be mathematically derived from the low-frequency portion of the receive signal. As such, the low-frequency portion of the receive signal can have a frequency that is less than or equal to 3400 Hz, and the high-frequency portion of the receive signal can have a frequency that is substantially between 3400 Hz and 8000 Hz, in addition, the bandsplitter 158 can also include a saturation detector configured to detect saturation based on a transient overflow resulting from the LPF operation. However, it is to be understood that the receive-path bandsplitter 158 does not include the transmit-path compensation element 210.

The bandsplitter 158 outputs the high-frequency portion 160 of the receive signal to a digital gain amplifier 164. The bandsplitter 158 also outputs a copy of the low-frequency portion 162 of the receive signal to a digital gain amplifier 166. The bandsplitter 158 outputs the low-frequency portion 162 of the receive signal to a downsampler 168. The downsampler 168 reduces the sample frequency of the low-frequency portion of the receive signal. As an example, the downsampler 168 can reduce the sample frequency of the low-frequency portion of the receive signal in half, such as, for example, from 16 kHz to 8 kHz. For example, the downsampler 168 can remove every other digital sample from the low-frequency portion of the receive signal to achieve the downsampling operation. For a sampling rate of 8 kHz, the Nyquist frequency is 4000 Hz. The frequency of the low-frequency portion of the receive signal, however, is 3400 Hz, which is less than the Nyquist frequency by 600 Hz. Because the low-frequency portion of the receive signal has a frequency that is less than the Nyquist frequency, the low-frequency portion of the receive signal has better anti-aliasing protection than a signal having a frequency that is at or more substantially near the Nyquist frequency. Therefore, the downsampler 168 can provide more accurate samples of the low-frequency portion of the receive signal at the 8 kHz sampling rate than a signal that is at or more substantially near the Nyquist frequency. The downsampled low-frequency portion of the receive signal is output from the downsampler 168 and input to the NLP 130 in the AER core 124.

As described above, the low-frequency portion of the receive signal includes the frequency range of typical person-to-person conversation. As such, performing acoustic echo suppression on the low-frequency portion of the receive signal at the downsampled frequency rate (e.g., 8 kHz) yields the most effective results for the removal of acoustic echo. In addition, because the acoustic echo suppression is performed on the low-frequency portion of the receive signal at the downsampled frequency rate, the removal of acoustic echo by the AER core 124 is more efficient as it requires less MIPS.

Referring to FIG. 4, the low-frequency portion of the receive signal, designated as Rx_PATH in the example of FIG. 4, is input to the NLP 130. As previously discussed, the dominant path decision block 136 receives Rx_PATH as an input and compares a relative signal strength of the low-frequency portions of both the transmit signal and the receive signal. Upon determining which of the transmit signal and the receive signal has the highest signal strength, the dominant path decision block 136 assigns the strongest signal as the dominant signal and the weakest signal as the non-dominant signal. As such, acoustic echo can be mitigated by attenuating the high-frequency portion of the non-dominant one of the transmit signal and the receive signal.

The signal Rx_PATH is input to the receive portion 134 of the NLP 130. In the receive portion 134 of the NLP 130, the low-frequency portion of the receive signal is switched to one of a plurality of digital gain amplifiers 170, 172, and 174. The digital gain amplifier 170 can apply an attenuation gain of G in dB to the low-frequency portion of the receive signal, where G is a number greater than zero. The digital gain amplifier 172 can apply an attenuation gain of G/2 to the low-frequency portion of the receive signal. The digital gain amplifier 174 can apply an attenuation gain of 0 dB to the low-frequency portion of the receive signal. The switching of the low-frequency portion of the receive signal can occur based on which of the transmit and receive signals is the dominant signal.

As an example, upon the transmit signal being the dominant signal, the low-frequency portion of the receive signal can be switched to the digital gain amplifier 170, such that the low-frequency portion of the receive signal is attenuated by a factor of G. As another example, upon a double-talk condition, wherein neither the receive signal nor the transmit signal is dominant, the low-frequency portion of the receive signal can be switched to the digital gain amplifier 172, such that the low-frequency portion of the receive signal is attenuated by a factor of G/2. As yet another example, upon the receive signal being the dominant signal, the low-frequency portion of the receive signal can be switched to the digital gain amplifier 174, such that the low-frequency portion of the receive signal is not attenuated due to the application of unity gain (e.g., 0 dB) by the digital gain amplifier 174. In addition, upon a saturation detector of the bandsplitter 158, similar to the saturation defector 212 in the example of FIG. 3, detecting saturation of the low-frequency portion of the transmit signal based on a transient overflow from the LPF operation, the saturation detector can optionally be configured to communicate with the receive portion 134 of the NLP 130 to increase the attenuation gain applied to the low-frequency portion of the receive signal. For example, the receive portion 134 of the NLP 130 can switch the low-frequency portion of the receive signal to a digital gain amplifier having a larger attenuation gain. As another example, the receive portion 134 of the NLP 130 can increase the value of the attenuation gain factor G in response to the defection of saturation in the low-frequency portion of the receive signal.

The timing component of the dominant path decision block 136 can switch the low-frequency portion of the receive signal gradually over the predetermined time upon a dominant signal transition. In addition, the switching of the low-frequency portion of the transmit signal between the digital gain amplifiers 144, 146, and 148 can be coordinated with the switching of the low-frequency portion of the receive signal between the digital gain amplifiers 170, 172, and 174 over the predetermined time. For example, upon a dominant signal transition from the transmit signal being dominant to the receive signal being dominant, the low-frequency portion of the transmit signal can be switched from the digital gain amplifier 148 to the digital gain amplifier 144 over the predetermined time. Concurrently over the predetermined time, the low-frequency portion of the receive signal is switched from the digital gain amplifier 170 to the digital gain amplifier 174.

Upon attenuating the low-frequency portion of the receive signal, the attenuated samples of the low-frequency portion of the receive signal output from the respective one of the digital gain amplifiers 170, 172, and 174 are not output from the NLP 130, but are instead discarded. However, the receive component 134 of the NLP 130 communicates the attenuation amount that was applied to the low-frequency portion of the receive signal to both the digital gain amplifier 164 and the digital gain amplifier 166 in the AER shell 112 in the example of FIG. 2, as indicated at 176. Specifically, the amount of attenuation that is applied to the low-frequency portion of the receive signal by the respective one of the digital gain amplifiers 170, 172, and 174 is likewise applied to both the high-frequency portion of the receive signal at the digital gain amplifier 164 and the copy of the low-frequency portion of the receive signal at the digital gain amplifier 166. As described above, it is to be understood that the digital gain amplifier 164 can completely attenuate the high-frequency portion of the receive signal upon the transmit signal being the dominant signal, as dictated by the dominant path decision block 136. Thus, the digital gain amplifier 164 applies substantially the same attenuation gain as the respective one of the digital gain amplifiers 170, 172, and 174 upon the receive signal being determined as the dominant signal. However, the digital gain amplifier 166, configured to attenuate the copy of the low-frequency portion of the receive signal at the 16 kHz sampling rate, can apply substantially the same attenuation gain as the respective one of the digital gain amplifiers 170, 172, and 174, regardless of whether the transmit signal or the receive signal is the dominant signal.

As previously stated, it is to be understood that the NLP 130 is not limited to the example of FIG. 4. For example, the low-frequency portion of the receive signal could be switched between more than just three digital gain amplifiers based on, for example, varying relative differences between signal strengths of the low-frequency portions of the transmit and receive signals. As another example, the digital gain amplifiers 170, 172, and 174 could apply different digital gain amounts other than G, G/2, and 0 dB, respectively, such that the gain amounts may not be linear with respect to each other.

Referring hack to FIG. 2, as described, above, the copy of the low-frequency portion of the receive signal is attenuated the same as the low-frequency portion of the receive signal in the AER core 124. As such, the copy of the low-frequency portion of the receive signal and the low-frequency portion of the receive signal are substantially identical signals at different sampling rates. The copy of the low-frequency portion of the receive signal output from the digital gain amplifier 166 and the high-frequency portion of the receive signal output from the digital gain amplifier 164 are each input to an adder 178. The high-frequency portion of the receive signal and the copy of the low-frequency portion of the receive signal can be readily added together because they are sampled at the same sampling rate. Thus, the adder 178 adds the copy of the low-frequency portion of the receive signal to the high-frequency portion of the receive signal to generate an attenuated receive signal. Acoustic echo resulting from the receive signal can be substantially mitigated as a result of the acoustic echo suppression performed by the NLP 130 on the low-frequency portion of the receive signal, as communicated to the high-frequency portion and the copy of the low-frequency portion of the receive signal. Because the attenuated receive signal is the sum of the high-frequency portion and the copy of the low-frequency portion of the receive signal, the low-frequency portion of the receive signal need not be output from the AER core 124 and upsampled to generate the attenuated receive signal. Therefore, processing delays associated with upsampling the low-frequency portion of the receive signal to generate the attenuated receive signal are substantially eliminated.

Upon being output from the adder 178, the receive signal is input to a receive-path equalizer 180. The receive path equalizer 180 is configured to filter and compensate for spectral response inherent in the speaker 108 that could affect the receive signal as heard by the near-end user. Upon being output from the receive path equalizer 180, the attenuated receive signal is input to a memory buffer 182. The memory buffer 182 could be, for example, a circular buffer.

The memory buffer 182 stores samples of the attenuated receive signal and outputs the samples after a predetermined delay. Upon being output from the memory buffer 182, the samples of the attenuated receive signal are input to a bandsplitter 184. The bandsplitter 184 outputs a low-frequency portion of the attenuated receive signal. Because the bandsplitter 184 does not output a high-frequency portion of the attenuated receive signal, the bandsplitter 184 may include an LPF. However, the bandsplitter 184 can include a saturation detector configured to detect saturation based on a transient overflow resulting from the LPF operation. The low-frequency portion of the attenuated receive signal can then be input to a downsampler 186. The downsampler 186 downsamples the low-frequency portion of the attenuated receive signal, for example, from 16 kHz to 8 kHz. The downsampled low-frequency portion of the attenuated receive signal is then input to the adaptive filter AEC 128. Accordingly, the memory buffer 182 operates to delay the samples of the attenuated receive signal, such that the adaptive filter AEC 128 can correlate the samples of the attenuated receive signal with samples of the transmit signal and thus substantially mitigate linearly predicted acoustic echo from the low-frequency portion of the transmit signal at the appropriate time. However, upon one or more of the saturation detectors of the bandsplitters 116, 158, and/or 184 defecting saturation of the low-frequency portion of the attenuated receive signal, the adaptive filter AEC 128 can half the adaptive filtering of the low-frequency portion of the transmit signal.

In addition to being output to the memory buffer 182, the attenuated receive signal is also input to a DAC 188. The DAC 188 converts the digital attenuated receive signal into an analog form. The analog receive signal is thus output to the speaker 108.

It is to be understood that FIG. 2 demonstrates but one example of a voice communications device having acoustic echo removal in accordance with an aspect of the invention. As such, the voice communication device 100 is not intended to be limited to the example of FIG. 2. For example, additional components can be included in the AER system 102 in the voice communication device 100 in the example of FIG. 2. As an example, additional digital gain amplifiers and high-level compensation devices can be included in the transmit path and/or the receive path, as necessary for a given application. As another example, at least some of the devices in the AER system 102 can be integrated together, either physically or in software.

In view of the foregoing structural and functional features described above, certain methods will be setter appreciated with reference to FIGS. 5 and 6. It is to be understood and appreciated that the illustrated actions, in other embodiments, may occur in different orders and/or concurrently with other actions. Moreover, not all illustrated features may be required to implement a method, it is to be further understood that the following methodologies can be implemented in hardware (e.g., analog or digital circuitry, such as may be embodied in an application specific integrated circuit or a computer system), software (e.g., as executable instructions stored on a computer readable media or running on one or more computer systems), or any combination of hardware and software.

FIG. 5 illustrates a method 250 for removing acoustic echo in a receive path of a voice communication device in accordance with an aspect of the invention. At 252, a receive signal is bandsplit into a high-frequency portion and a low-frequency portion. The bandsplitting can occur such that the low-frequency portion of the receive signal is less than or equal to 3400 Hz and the high-frequency portion of the receive signal is between 3400 and 8000 Hz. At 254, the low-frequency portion of the receive signal is downsampled. The downsampling can be from a sample frequency of 16 kHz to 8 kHz.

At 256, acoustic echo removal is applied to the low-frequency portion of the receive signal. The acoustic echo removal can include acoustic echo suppression. Acoustic echo suppression can occur by applying an attenuation gain to the low-frequency portion of the receive signal. The amount of attenuation gain can be based on a determination of whether the transmit signal or the receive signal is dominant. The same amount of attenuation gain can also be applied to a copy of the low-frequency portion of the receive signal that is sampled at the original (i.e., higher) sampling rate. In addition, the same amount of attenuation gain can also be applied to the high-frequency portion of the receive signal if the receive signal is dominant. At 258, the copy of the low-frequency portion and the high-frequency portion of the receive signal are added together to generate an attenuated receive signal. Because the high-frequency portion and the copy of the low-frequency portion of the receive signal are at the same sample frequency, the low-frequency portion upon which the acoustic echo suppression is performed need not be upsampled and added to the high-frequency portion of the receive signal.

The methodology in the example of FIG. 5 demonstrates mitigating acoustic echo by attenuating a receive path of a voice communication device in a wide-band mode, such as for a receive path signal that is approximately 8 kHz sampled at approximately 16 kHz. It is to be understood, however, that a voice communications device implementing the method of FIG. 5 can be switched to a low-band mode, similar to as described above in the example of FIG. 1. As such, acoustic echo can be substantially mitigated for a receive path signal that is approximately 4 kHz sampled at approximately 8 kHz provided from at least one voice processor.

FIG. 6 illustrates a method 300 for removing acoustic echo in a transmit path of a voice communication device in accordance with an aspect of the invention. At 302, a transmit signal is bandsplit into a high-frequency portion and a low-frequency portion. The bandsplitting can occur such that the low-frequency portion of the transmit signal is less than or equal to 3400 Hz and the high-frequency portion of the transmit signal is between 3400 and 8000 Hz. At 304, a compensation component is subtracted from the high-frequency portion of the transmit signal. The compensation component can include distortion associated with at least one of normalization, downsampling, upsampling, and low-pass filtering of the low-frequency portion of the transmit signal. At 306, the low-frequency portion of the transmit signal is downsampled. The downsampling can be from a sample frequency of 16 kHz to 8 kHz.

At 308, acoustic echo removal is applied to the low-frequency portion of the transmit signal. The acoustic echo removal could include acoustic echo cancellation and/or suppression. Acoustic echo cancellation can occur by adaptively filtering samples of an attenuated receive signal that have been substantially timed with the transmit signal, and subtracting linearly predicted acoustic echo from the low-frequency portion of the transmit signal based on the attenuated receive signal. Acoustic echo suppression can occur by applying an attenuation gain to the low-frequency portion of the transmit signal. The amount of attenuation gain can be based on a determination of whether the transmit signal or the receive signal is dominant. The same amount of attenuation gain can also he applied to the high-frequency portion of the transmit signal. At 310, the low-frequency portion of the transmit signal is upsampled. The upsampling can be from 8 kHz back to 16 kHz. At 312, the low-frequency portion and the high-frequency portion of the transmit signal are added together to generate an attenuated transmit signal. The attenuated transmit signal can be a substantially identical reconstruction of the original transmit signal due to the compensation component that was subtracted from the high-frequency portion of the transmit signal.

The methodology in the example of FIG. 6 demonstrates removing acoustic echo in a transmit path of a voice communication device in a wide-band mode, such as for a receive path signal that is approximately 8 kHz sampled at approximately 16 kHz. It is to be understood, however, that a voice communications device implementing the method of FIG. 6 can be switched to a low-band mode, such that acoustic echo can be substantially mitigated for a transmit path signal that has spectral content of up to 4 kHz sampled at approximately 8 kHz, similar to as described above in the example of FIG. 1. For example, a low-frequency portion of a transmit signal can be provided from an AER shell directly to at least one voice processor.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. An acoustic echo removal system comprising:
a transmit path configured to propagate a transmit signal between a microphone and at least one voice processor, the transmit signal comprising a high-frequency portion and a low-frequency portion;
a receive path configured to propagate a receive signal between the at least one voice processor and a speaker, the receive signal comprising a high-frequency portion and a low-frequency portion;
a first acoustic echo removal portion configured to determine a first variable attenuation gain and to provide the first variable attenuation gain to the low-frequency portion of the transmit signal at a first sample frequency and to provide a second variable attenuation gain to the low-frequency portion of the receive signal at the first sample frequency; and
a second acoustic echo removal portion configured to provide the first variable attenuation gain to the high-frequency portion of the transmit signal at a second sample frequency and to provide the second variable attenuation gain to both the high-frequency portion of the receive signal and a copy of the low-frequency portion of the receive signal at the second sample frequency, the second sample frequency being greater than the first sample frequency.

2. The system of claim 1, wherein the low-frequency portion of both the transmit signal and the receive signal has a frequency that is less than or equal to 3400 Hz, and wherein the first sample frequency is approximately 8 kHz and the second sample frequency is approximately 16 kHz.

3. The system of claim 1, wherein the transmit path comprises a transmit-path bandsplitter configured to input the transmit signal and to output the low-frequency portion and the high-frequency portion of the transmit signal, and wherein the receive path comprises a receive-path bandsplitter configured to input the receive signal and to output the low-frequency portion, the copy of the low frequency portion, and the high-frequency portion of the receive signal.

4. The system of claim 3, wherein the transmit-path bandsplitter comprises a low-pass filter configured to generate the low-frequency portion of the transmit signal and a subtractor configured to subtract the low-frequency portion of the transmit signal from the transmit signal to generate the high-frequency portion of the transmit signal, and wherein the receive-path bandsplitter comprises a low-pass filter configured to generate the low-frequency portion of the receive signal and a subtractor configured to subtract the low-frequency portion of the receive signal from the receive signal to generate the high-frequency portion of the receive signal.

5. The system of claim 1, wherein the receive path further comprises an adder configured to add the high-frequency portion and the copy of the low-frequency portion of the receive signal to generate an attenuated receive signal, and wherein the transmit path further comprises an upsampler configured to increase a sample frequency associated with the low-frequency portion of the transmit signal from the first sample frequency to the second sample frequency, and an adder configured to add the high-frequency portion and the low-frequency portion of the transmit signal to generate an attenuated transmit signal.

6. The system of claim 5, wherein the high-frequency portion of the transmit signal comprises a compensation component, the compensation component comprising distortion associated with at least one of normalization, downsampling, upsampling, and low-pass filtering of the low-frequency portion of the transmit signal, such that the attenuated transmit signal is a substantially identical reconstruction of the transmit signal.

7. The system of claim 5, wherein the first acoustic echo removal portion comprises an adaptive filter acoustic echo canceller in the transmit path configured to receive the attenuated receive signal and to subtract linearly predicted acoustic echo from the low-frequency portion of the transmit signal based on the attenuated receive signal.

8. The system of claim 1, wherein the acoustic echo removal system is switchable between a wide-band mode and a low-band mode, such that the second acoustic echo removal portion is configured to provide the first variable attenuation gain to the high-frequency portion of the transmit signal at the second sample frequency and to provide the second variable attenuation gain to both the high-frequency portion of the receive signal and the copy of the low-frequency portion of the receive signal at the second sample frequency only in the wide-band mode.

9. The system of claim 1, wherein the first acoustic echo removal portion, upon applying the first variable attenuation gain to the low-frequency portion of the transmit signal, provides an output of the low-frequency portion of the transmit signal at the first sample frequency directly to the at least one voice processor.

10. The system of claim 1, wherein the first acoustic echo removal portion comprises a dominant path decision block that is configured to determine which of the receive signal and the transmit signal is a dominant signal based on an associated signal strength, and wherein the first variable attenuation gain increases and the second variable attenuation gain decreases gradually over a predetermined time upon the receive signal being the dominant signal, the second variable attenuation gain increases and the first variable attenuation gain decreases gradually over the predetermined time upon the transmit signal being the dominant signal, and the high-frequency portion of one of the receive signal and the transmit signal is gradually completely attenuated over the predetermined time upon the other one of the receive signal and the transmit signal becoming the dominant signal.

11. The system of claim 1, wherein each of the transmit path and the receive path comprise a saturation detector operative, upon detecting saturation of the low-frequency portion of the respective transmit signal and receive signal based on a transient overflow, to command the second acoustic echo removal portion to increase the respective one of the first variable attenuation gain and the second variable attenuation gain.

12. An acoustic echo removal system comprising:
a receive-path bandsplitter configured to split a receive signal into a high-frequency portion, a low-frequency portion, and a copy of the low-frequency portion;
a receive-path downsampler configured to reduce a sample frequency associated with the low-frequency portion of the receive signal from a first sample frequency to a second sample frequency;
a receive-path portion of a non-linear processor configured to apply a receive attenuation gain to the low-frequency portion of the receive signal at the second sample frequency;
a receive-path attenuator configured to apply the receive attenuation gain to both the high-frequency portion of the receive signal and the copy of the low-frequency portion of the receive signal; and
a receive-path adder configured to add the high-frequency portion and the copy of the low-frequency portion of the receive signal to generate an attenuated receive signal.

13. The system of claim 12, further comprising:
a transmit-path bandsplitter configured to split a transmit signal into a high-frequency portion and a low-frequency portion;
a transmit-path downsampler configured to reduce a sample frequency associated with the low-frequency portion of the transmit signal from the first sample frequency to the second sample frequency;
a transmit-path portion of a non-linear processor configured to apply a transmit attenuation gain to the low-frequency portion of the transmit signal at the second sample frequency;
a transmit-path attenuator configured to apply the transmit attenuation gain to the high-frequency portion of the transmit signal at the first sample frequency;
a transmit-path upsampler configured to increase the sample frequency associated with the low-frequency portion of the transmit signal from the second sample frequency to the first sample frequency; and
a transmit-path adder configured to add the high-frequency portion and the low-frequency portion of the transmit signal to generate an attenuated transmit signal.

14. The system of claim 13, wherein the transmit-path bandsplitter is further configured to subtract a compensation component from the high-frequency portion of the transmit signal, the compensation component comprising distortion associated with at least one of normalization, downsampling, upsampling, and low-pass filtering of the low-frequency portion of the transmit signal, such that the attenuated transmit signal is a substantially identical reconstruction of the transmit signal.

15. The system of claim 13, wherein the transmit-path portion of a non-linear processor, upon applying the transmit attenuation gain to the low-frequency portion of the transmit signal, provides an output of the low-frequency portion of the transmit signal at the second sample frequency directly to at least one voice processor with which the acoustic echo removal system is associated.

16. The system of claim 13, wherein the transmit-path portion of a non-linear processor comprises an adaptive filter acoustic echo canceller configured to receive the attenuated receive signal and to subtract linearly predicted acoustic echo from the low-frequency portion of the transmit signal based on the attenuated receive signal.

17. The system of claim 13, further comprising a dominant path decision block that is configured to determine which of the receive signal and the transmit signal is a dominant signal based on an associated signal strength, such that the other of the receive signal and the transmit signal is a non-dominant signal, the dominant path decision block also being configured to gradually completely attenuate the high-frequency portion of the non-dominant signal over a predetermined time.

18. The system of claim 17, wherein the transmit attenuation gain and the receive attenuation gain are each variable and substantially complementary based on which of the receive signal and the transmit signal is the dominant signal, such that the transmit attenuation gain is increased and the receive attenuation gain is decreased gradually over the predetermined time upon the receive signal being the dominant signal, and the receive attenuation gain is increased and the transmit attenuation gain is decreased gradually over the predetermined time upon the transmit signal being the dominant signal.

19. The system of claim 12, wherein the receive-path bandsplitter comprises a low-pass filter and a subtractor, such that the receive signal is input to both the low-pass flier and the subtractor, the low-pass filter being configured to generate the low-frequency portion of the receive signal and the subtractor being configured to subtract the low-frequency portion of the receive signal from the receive signal to generate the high-frequency portion of the receive signal.

20. The system of claim 12, wherein the low-frequency portion of the receive signal has a frequency that is less than or equal to 3400 Hz, and wherein the first sample frequency is approximately 16 kHz and the second sample frequency is approximately 8 kHz.

21. The system of claim 12, wherein the receive-path downsampler comprises a saturation defector operative, upon detecting saturation of the low-frequency portion of the receive signal based on a transient overflow, to command the receive-path portion of a non-linear processor to increase the receive attenuation gain.

22. A method of removing acoustic echo in a voice communication device, the method comprising:
bandsplitting a transmit signal into a high-frequency portion and a low-frequency portion;
subtracting a compensation component from the high-frequency portion of the transmit signal, the compensation component comprising distortion associated with at least one of normalization, downsampling, upsampling, and low-pass filtering of the low-frequency portion of the transmit signal;
downsampling the low-frequency portion of the transmit signal from a first sample frequency to a second sample frequency;
applying a first variable attenuation gain on the low-frequency portion of the transmit signal at the second sample frequency and on the high-frequency portion of the transmit signal at the first sample frequency;
upsampling the low-frequency portion of the transmit signal from the second sample frequency to the first sample frequency; and
adding the low-frequency portion and the high-frequency portion of the transmit signal to generate an attenuated transmit signal, such that the attenuated transmit signal is a substantially identical reconstruction of the transmit signal.

23. The method of claim 22, further comprising providing the low-frequency portion of the transmit signal at the second sample frequency directly to at least one voice processor associated with the voice communication device.

24. The method of claim 22, further comprising:
bandsplitting a receive signal into a high-frequency portion, a low-frequency portion, and a copy of the low-frequency portion;
downsampling the low-frequency portion of the receive signal from the first sample frequency to the second sample frequency;
applying a second variable attenuation gain on the low-frequency portion of the receive signal at the second sample frequency, and applying the second variable attenuation gain on the high-frequency portion of the receive signal and the copy of the low-frequency portion of the receive signal at the first sample frequency; and
adding the copy of the low-frequency portion and the high-frequency portion of the receive signal to generate an attenuated receive signal.

25. The method of claim 24, further comprising delaying samples of the attenuated receive signal and adaptively filtering the low-frequency portion of the transmit signal at the second sample frequency based on the delayed samples of the attenuated receive signal.

26. The method of claim 25, further comprising:
comparing a first signal strength associated with the low-frequency portion of the receive signal and a second signal strength associated with the low-frequency portion of the transmit signal;
assigning one of the receive signal and the transmit signal as a dominant signal based on the comparison of the first signal strength and the second signal strength;
assigning the other of the receive signal and the transmit signal as a non-dominant signal;
gradually completely attenuating the high-frequency portion of the non-dominant signal over a predetermined time;
decreasing the first variable attenuation gain and increasing the second variable attenuation gain gradually over the predetermined time upon the transmit signal being the dominant signal; and
decreasing the second variable attenuation gain and increasing the first variable attenuation gain gradually over the predetermined time upon the receive signal being the dominant signal.

27. The method of claim 25, further comprising:
detecting saturation associated with downsampling the low-frequency portions of each of the transmit signal, the receive signal, and the delayed samples of the attenuated receive signal based on a transient overflow;
increasing the second variable attenuation gain in response to detecting saturation of the low-frequency portion of the receive signal;
increasing the first variable attenuation gain in response to detecting saturation of the low-frequency portion of the transmit signal; and
halting the adaptive filtering of the low-frequency portion of the transmit signal in response to defecting saturation of the delayed samples of the attenuated receive signal.

28. The method of claim 24, wherein the bandsplitting of the transmit signal and the receive signal each comprises bandsplitting the transmit signal and the receive signal, respectively, into a low-frequency portion having a frequency that is less than or equal to 3400 Hz and a high-frequency portion having a frequency that is between 3400 Hz and 8000 Hz, and wherein the first sample frequency is approximately 16 kHz and the second sample frequency is approximately 8 kHz.

29. The method of claim 24, wherein the bandsplitting of the transmit signal comprises low-pass filtering the transmit signal to generate the low-frequency portion of the transmit signal and subtracting the low-frequency portion of the transmit signal from the transmit signal to generate the high-frequency portion of the transmit signal, and wherein the bandsplitting of the receive signal comprises low-pass filtering the receive signal to generate the low-frequency portion of the receive signal and subtracting the low-frequency portion of the receive signal from the receive signal to generate the high-frequency portion of the receive signal.
